(19) United States
(12) Patent Application Publication
(10) Pub. No.: US 2010/0097793 A1
(43) Pub. Date: Apr. 22, 2010

(54) POWER SAVING STREETLAMP DEVICE

(76) Inventor: Chien-Chih Kuo, Taipei City (TW)

Correspondence Address: Chien-Chih Kuo, 235 Chung - Ho Box 8-24, Taipei, 235, TW

(21) Appl. No.: 12/256,459

(22) Filed: Oct. 22, 2008

(51) Int. Cl. F21V 29/00; F21V 7/04

(52) U.S. Cl. 362/218; 362/217.05

(57) ABSTRACT

A power saving streetlamp device comprises a reflecting mask having a hopper shape with a small upper opening and a large lower opening; a lamp tube having a longer longitudinal side and a shorter transversal side; and a lamp seat having a receiving space for receiving one end of the longitudinal side of the lamp tube; the lamp seat being retained to the small opening of the reflecting mask; light emitted from the lamp tube will incident to inner walls of the reflecting mask and then reflected by the wall to transfer downwards.

### FIELD OF THE INVENTION

The present invention relates to streetlamp, and particularly to a power saving streetlamp device.

### BACKGROUND OF THE INVENTION

There are many prior arts about the streetlamps, such as U.S. Pat. No. 7,329,030, U.S. Pat. No. 6,254,623, etc. However in all the prior art streetlamps, the most important problems are illumination efficiency and heat dissipation ability. Although the lamp tube is gradually changed from conventional lamp tubes to LEDs (light emitting diodes) for enhancing light emitting ability. However in the prior art the lamp tube is arranged transversally so that light is possible transmitted to lateral side instead of all light being projected downwards so that the efficiency of the illumination is low. However if all light from the lamp tube can project downwards, the illumination will be increased.

### SUMMARY OF THE INVENTION

Accordingly, the object of the present invention is to provide a power saving streetlamp device, wherein a lamp tube is approximately vertical to a bottom plate and by the design of the reflecting mask, light from the lamp tube will incident downwards with a higher intensity and higher efficiency. The reflecting mask 1 is integrally formed so that light can be transferred out completely. A fin set is formed at the upper side of the lamp casing for increasing heat dissipation so as to protect the lamp device from the overheat and prolong the lifetime of the whole structure.

To achieve above object, the present invention provides a power saving streetlamp device comprising: a reflecting mask having a hopper shape with a small upper opening and a large lower opening; a lamp tube having a longer longitudinal side and a shorter transversal side; a lamp seat having a receiving space for receiving one end of the longitudinal side of the lamp tube; the lamp seat being retained to the small opening the reflecting mask; light emitted from the lamp tube will incident to inner walls of the reflecting mask and then reflected by the wall to transfer downwards.

The power saving streetlamp device further comprises a bottom plate for sealing a bottom of the lamp casing; the bottom plate has an opening for transmission of light; after installation, the longitudinal side of the lamp tube is approximately vertical to the bottom plate. A lamp casing having a receiving chamber at an inner bottom; an upper outer side of the lamp casing has a fin set for increasing an area for heat dissipation. A ballast installed at the upper portion of the lamp casing.

### BRIEF DESCRIPTION OF THE DRAWINGS

FIG. 1 is a perspective view of the reflecting mask of the present invention.

FIG. 2 is a perspective view showing the lamp seat of the present invention.

FIG. 3 is a perspective view about the lamp tube of the present invention.

FIGS. 4(A) and 4(B) are perspective view and inner view of the lamp casing of the present invention.

FIGS. 5(A) and 5(B) are perspective view and assembled view of the present invention.

FIG. 6 is a schematic view showing the assembly view of the present invention.

FIG. 7 is a schematic view showing the connection of the reflecting mask and the lamp casing of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Referring to the following described. The power saving streetlamp of the present invention is illustrated. The streetlamp has the following elements.

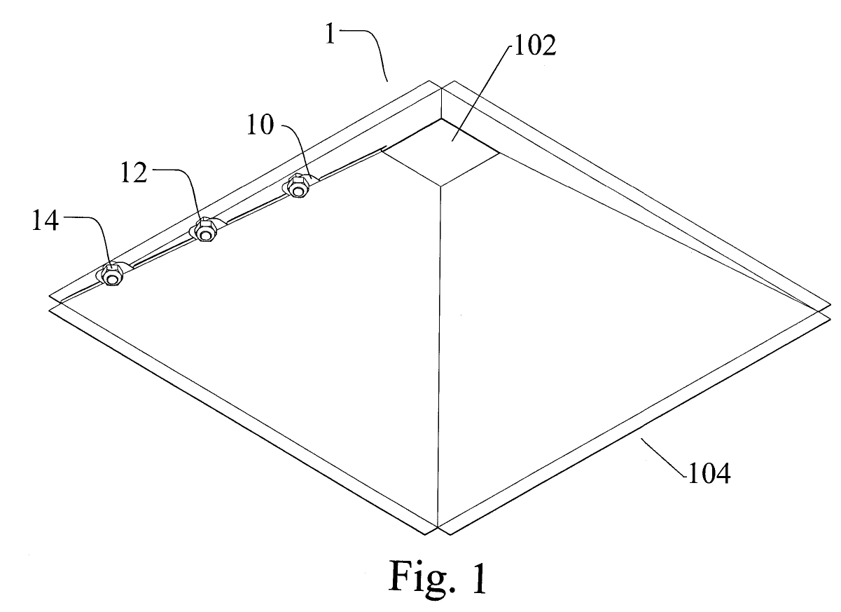

A reflecting mask 1, as illustrated in FIG. 1 of the present invention, has an approximate hopper shape which has an upper opening and a lower opening. The reflecting mask 1 is made integrally with only for connecting edge 10 which are connected by studs 12 and nuts 14. The shape of the hopper is varied, such as a rectangular hopper or a round cylindrical hopper so as to have a preferred light reflecting effect. In this the present invention, the reflecting mask 1 has a small upper rectangular opening 102 and a large lower rectangular opening 104 (referring to FIG. 1).

A lamp tube 2 has a longer longitudinal side and a shorter transversal side.

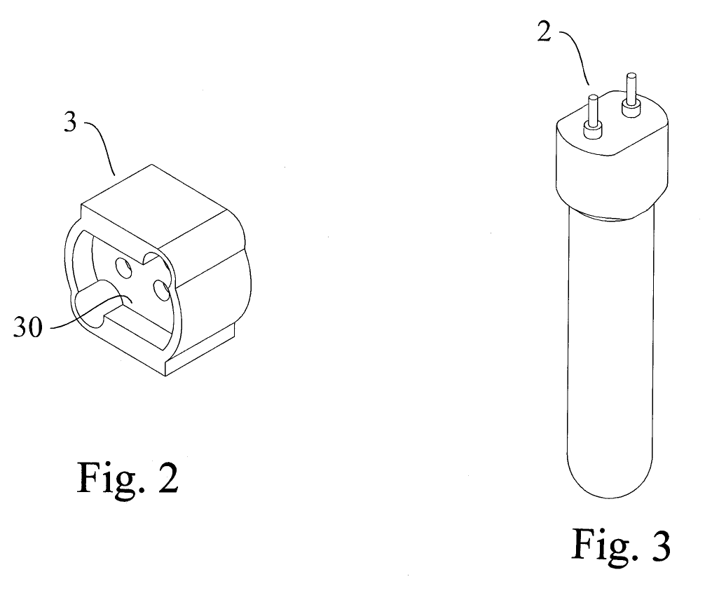

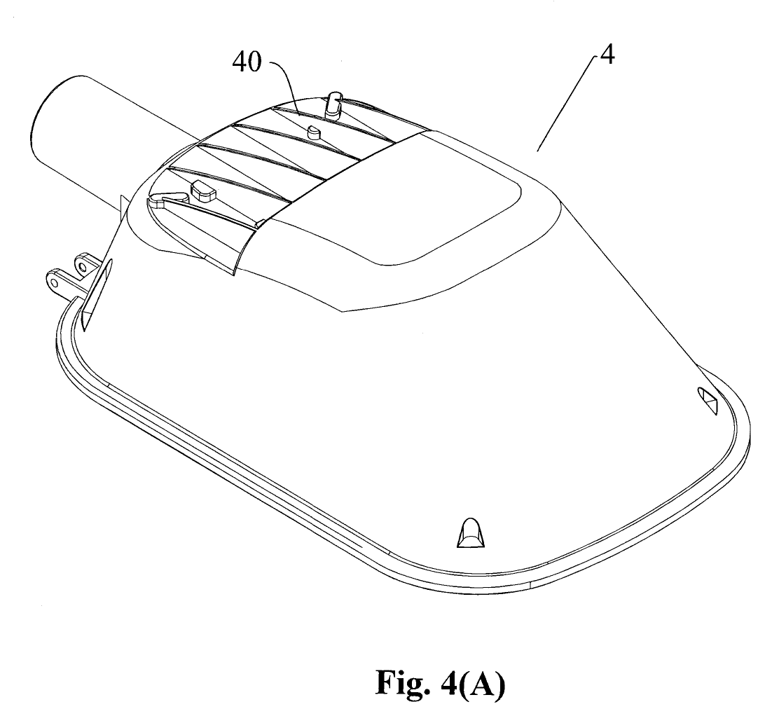

A lamp seat 3 has a receiving space 30 for receiving one end of the longitudinal side of the lamp tube 2. The lamp seat 3 is retained to the small opening the reflecting mask 1. Light emitted from the lamp tube 2 will incident to inner walls of the reflecting mask 1 and then reflected by the wall to transfer downwards (referring to FIGS. 2 and 3).

In the present invention, the lamp tube 2 may be an HID (High Intensity Discharge Lamps) lamp tube which is high illumination, high efficiency and lower power consumption.

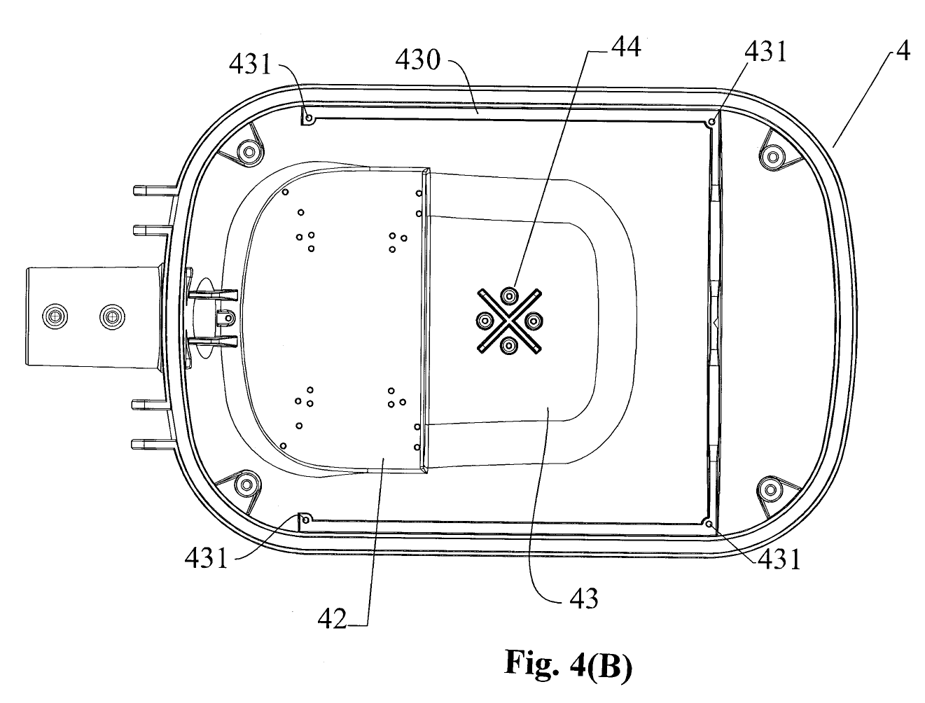

A lamp casing 4 has a receiving chamber 41 at an inner bottom (referring to FIGS. 4(A) and 4(B)). The receiving chamber 41 has a stepped shape including an upper portion 42 and a lower portion 43 for receiving various elements. An upper outer side of the lamp casing 4 has a fin set 40 for increasing an area for heat dissipation. In the present invention, the lamp casing 4 may be made of aluminum alloy which is good heat conductive material.

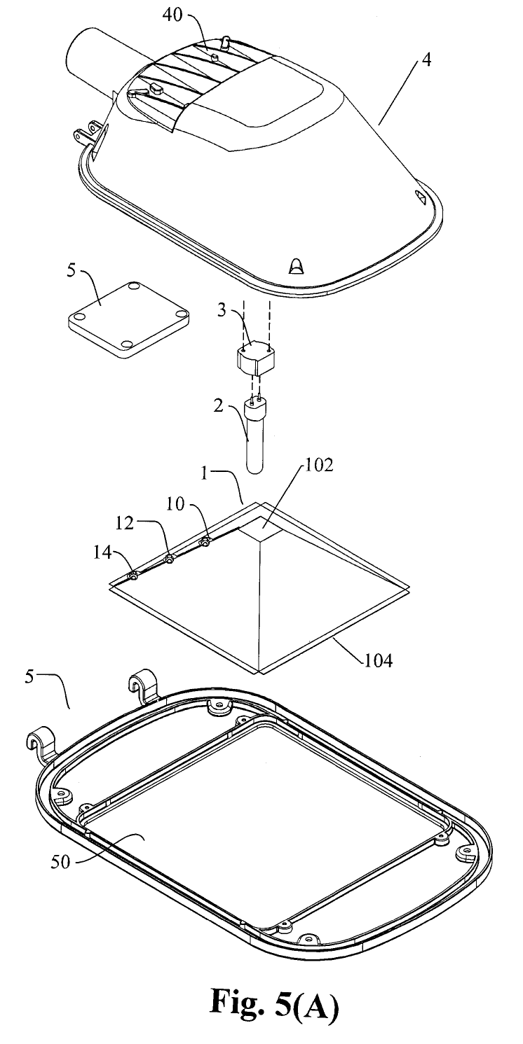

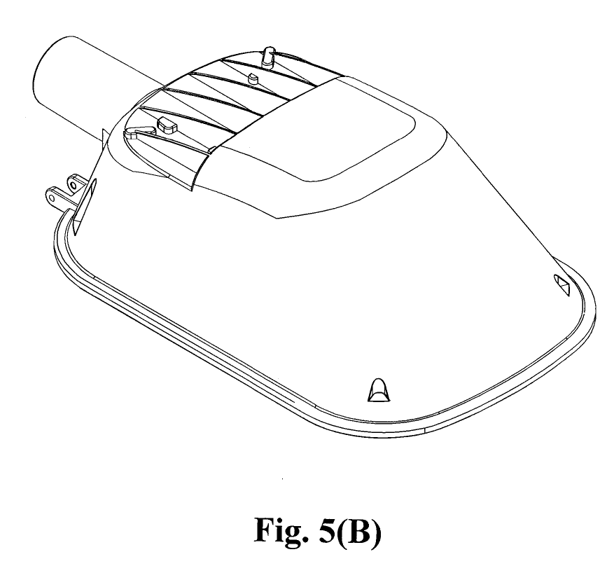

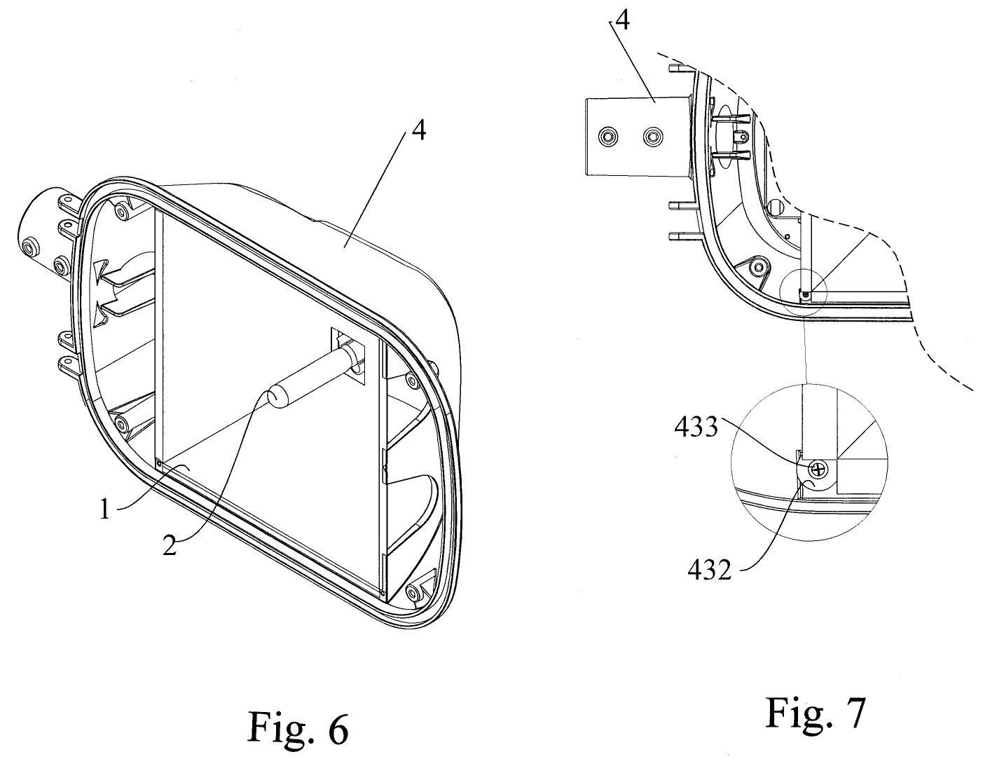

A ballast 5 is installed at the upper portion 42 of the lamp casing 4 for providing preferred actuation voltage to the lamp tube 2. The lower portion 43 serves to receive the reflecting mask 1, lamp seat 3 and lamp tube 2. The lower portion 43 has a connecting positioning portion 44 for connecting the lamp seat 3 so that the lamp seat 3 and lamp tube 2 can be retained to the lamp casing 4. Each of three sides of the receiving chamber 41 has a respective projection 430. Each of two ends of each projection 430 has a locking hole 431 so as to lock the reflecting mask 1 by pads 432 and screw 433 (only one set is illustrated) for retaining the lamp casing 4 (referring to FIGS. 5(A) to 7).

A bottom plate 5 serves for sealing a bottom of the lamp casing 4. The bottom plate 5 has an opening for transmission of light. The opening may be sealed by transparent material, such as plastics or glass (referring to FIG. 5(A)). After installation, the longitudinal side of the lamp tube 2 is approximately vertical to the bottom plate 5.

In the present invention, since the lamp tube 2 is approximately vertical to the bottom plate 5 and by the design of the reflecting mask 1, the light from the lamp tube 2 will incident downwards with a higher intensity and higher efficiency. Especially the lamp tube 2 is an HID lamp tube with higher illumination. The reflecting mask 1 is integrally formed so that light can be transferred out completely. The light from the lamp tube 2 can be transferred with a higher efficiency. The fin set at the upper side of the lamp casing 4 will increase the heat dissipation so as to protect the lamp device from the overheat and prolong the lifetime of the whole structure.

To be described here, the lamp tube 2 may be other light source other than HID.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A power saving streetlamp device comprising:
a reflecting mask having a hopper shape with a small upper opening and a large lower opening;
a lamp tube having a longer longitudinal side and a shorter transversal side; and
a lamp seat having a receiving space for receiving one end of the longitudinal side of the lamp tube; the lamp seat being retained to the small opening of the reflecting mask; light emitted from the lamp tube will incident to inner walls of the reflecting mask and then reflected by the wall to transfer downwards.

2. The power saving streetlamp device as claimed in claim 1, further comprising a bottom plate for sealing a bottom of the lamp casing; the bottom plate has an opening for transmission of light; after installation, the longitudinal side of the lamp tube is approximately vertical to the bottom plate.

3. The power saving streetlamp device as claimed in claims 1, further comprising: a lamp casing having a receiving chamber at an inner bottom; an upper outer side of the lamp casing has a fin set for increasing an area for heat dissipation.

4. The power saving streetlamp device as claimed in claim 3, further comprising: a ballast installed at the upper portion of the lamp casing.

5. The power saving streetlamp device as claimed in claims 3, wherein a lower portion of the receiving chamber of the lamp casing having a connecting positioning portion for connecting the lamp seat so that the lamp seat and lamp tube are retained to the lamp casing.

6. The power saving streetlamp device as claimed in claims 1, wherein the reflecting mask has an integral structure with only one connecting edge.

7. The power saving streetlamp device as claimed in claims 1, wherein the lamp tube is an HID lamp tube.

8. The power saving streetlamp device as claimed in claim 3, wherein the lamp casing is made of aluminum alloy.

9. The power saving streetlamp device as claimed in claim 3, wherein each of three sides of the receiving chamber has a respective projection; each of two ends of each projection has a locking hole so as to lock the reflecting mask by pads and screw for retaining the lamp casing.

10. The power saving streetlamp device as claimed in claim 2, wherein the opening is sealed by transparent material.
